(19) United States
(12) Patent Application Publication
(10) Pub. No.: US 2014/0241406 A1
(43) Pub. Date: Aug. 28, 2014

(54) WIRELESS COMMUNICATIONS SYSTEM PERFORMING TRANSMISSION AND RECEPTION ACCORDING TO OPERATIONAL STATES OF CO-LOCATED INTERFACE APPARATUS AND RELATED WIRELESS COMMUNICATIONS METHOD THERE OF

(71) Applicant: Mediatek Inc., Hsin-Chu (TW)

(72) Inventors: Ching-Hwa Yu, Tainan City (TW); Cheok Yan Goh, Hsinchu City (TW); Yu-Hsun Chen, Hsinchu County (TW); Horng-Bin Wang, Hsinchu City (TW); Mao-Lin Wu, Hsinchu County (TW); Chih-Chieh Chou, Taipei City (TW); Tsung-Yueh Hsieh, Tainan City (TW); I-Lin Hsieh, Hsinchu City (TW)

(73) Assignee: Mediatek Inc., Hsin-Chu (TW)

(21) Appl. No.: 14/191,442

(22) Filed: Feb. 27, 2014

Related U.S. Application Data
(60) Provisional application No. 61/769,968, filed on Feb. 27, 2013.

(51) Int. Cl. H04L 1/00; H04B 15/02

(52) U.S. Cl. CPC H04L 1/0027; H04B 15/02
USPC 375/219

(57) ABSTRACT

A wireless communications system co-located with an interface apparatus includes a radio subsystem. The radio subsystem includes a transmission circuit arranged for performing a radio transmission, and a reception circuit arranged for performing a radio reception when the interface apparatus operates in a first operational state. The interface apparatus operates in one of a plurality of operational states including the first operational state and a second operational state, and a power consumption of the interface apparatus in the first operational state is lower than a power consumption of the interface apparatus in the second operational state.

### CROSS REFERENCE TO RELATED APPLICATIONS

This application claims the benefit of U.S. provisional application No. 61/769,968, filed on Feb. 27, 2013 and incorporated herein by reference.

### BACKGROUND

Universal serial bus (USB) 3.0 or Super-Speed USB has a 5G bit/s signaling rate and requires data to be scrambled and applied to spread spectrum on the clock, meaning the USB 3.0 data spectrum could be ranging from DC to 5 GHz. However, the noise radiated from the USB 3.0 cable or connector is high in the 2.4-2.5 GHz ISM (industrial, scientific and medical) band, which is an unlicensed radio frequency band widely used by standard protocols such as IEEE 802.11 b/g/n, Bluetooth, Zigbee, proprietary protocols, etc. The broadband interference noise emitted from a USB 3.0 interface can affect the signal-to-noise ratio (SNR) and limit the sensitivity of co-located ISM radio subsystems.

Traditionally, this problem is addressed by applying a shielding to the USB 3.0 peripheral devices or receptacle connectors. However, this shielding method can only bring mild improvement and is very hard to implement when it comes to compact devices. Another conventional method proposed is antenna placement, which is to re-arrange a position of an antenna in order to have a better SNR. Similarly, implementing this method on the compact devices is a difficult task.

There is a need, therefore, for an innovative solution to mitigate interference noises radiated from cables or connectors of a super-speed USB interface device.

### SUMMARY

In accordance with exemplary embodiments of the present invention, a wireless communications system performing transmission and reception according to operational states of co-located universal serial bus interface apparatus and related wireless communications method thereof, are proposed to solve the above-mentioned problem.

According to a first aspect of the present invention, an exemplary wireless communications system is disclosed. The wireless communications system is co-located with an interface apparatus and includes a radio subsystem. The radio subsystem includes a transmission circuit and a reception circuit. The reception circuit is arranged for performing a radio reception when the interface apparatus operates in a first operational state. The interface apparatus operates in one of a plurality of operational states including the first operational state and a second operational state. A power consumption of the interface apparatus in the first operational state is lower than a power consumption of the interface apparatus in the second operational state.

According to a second aspect of the present invention, an exemplary wireless communications method is disclosed. The wireless communications method for radio subsystem co-located with an interface apparatus. The wireless communications method includes steps performing a radio reception when the interface apparatus operates in a first operational state, wherein the interface apparatus operates in one of a plurality of operational states including the first operational state and a second operational state, and a power consumption of the interface apparatus in the first operational state is lower than a power consumption of the interface apparatus in the second operational state.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a wireless communications system co-located with a universal serial bus (USB) interface apparatus according to a first embodiment of the present invention.

FIG. 2 is a schematic diagram illustrating a time-division multiplexing scheme for the wireless communications system co-located with the USB interface apparatus in FIG. 1 according to a second embodiment of the present invention.

FIG. 3 is a schematic diagram illustrating a time-division multiplexing scheme for the wireless communications system co-located with the USB interface apparatus in FIG. 1 according to a third embodiment of the present invention.

FIG. 4 is a schematic diagram illustrating a time-division multiplexing scheme for the wireless communications system co-located with the USB interface apparatus in FIG. 1 according to a fourth embodiment of the present invention.

FIG. 5 is a schematic diagram illustrating a time-division multiplexing scheme for the wireless communications system co-located with the USB interface apparatus in FIG. 1 according to a fifth embodiment of the present invention.

FIG. 6 is a schematic diagram illustrating a time-division multiplexing scheme for the wireless communications system co-located with the USB interface apparatus in FIG. 1 according to a sixth embodiment of the present invention.

FIG. 7 is a schematic diagram illustrating a time-division multiplexing scheme for the wireless communications system co-located with the USB interface apparatus in FIG. 1 according to a seventh embodiment of the present invention.

FIG. 8 is a schematic diagram illustrating a time-division multiplexing scheme for the wireless communications system co-located with the USB interface apparatus in FIG. 1 according to an eighth embodiment of the present invention.

FIG. 9 is a schematic diagram illustrating a time-division multiplexing scheme for the wireless communications system co-located with the USB interface apparatus in FIG. 1 according to a ninth embodiment of the present invention.

FIG. 10 is a schematic diagram illustrating a time-division multiplexing scheme for the wireless communications system co-located with the USB interface apparatus in FIG. 1 according to a tenth embodiment of the present invention.

FIG. 11 is a schematic diagram illustrating a time-division multiplexing scheme for the wireless communications system co-located with the USB interface apparatus in FIG. 1 according to an eleventh embodiment of the present invention.

FIG. 12 is a schematic diagram illustrating a time-division multiplexing scheme for the wireless communications system co-located with the USB interface apparatus in FIG. 1 according to a twelfth embodiment of the present invention.

FIG. 13 is a schematic diagram illustrating a time-division multiplexing scheme for the wireless communications system co-located with the USB interface apparatus in FIG. 1 according to a thirteenth embodiment of the present invention.

FIG. 14 is a schematic diagram illustrating a time-division multiplexing scheme for the wireless communications system co-located with the USB interface apparatus in FIG. 1 according to a fourteenth embodiment of the present invention.

FIG. 15 is a flowchart of a wireless communications method employed by at least one subsystem of the wireless communications system co-located with the USB interface apparatus in FIG. 1.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

The concept of the present invention is associated with a time-division multiplexing scheme for mitigation of a super-speed universal serial bus (USB) interface radiated interference noises. More specifically, it is regarding exploiting periods of low-power states of a USB interface device for performing transmission/reception of co-located radio subsystems. The time-division multiplexing scheme is applied by alignment of the transmission/reception of co-located radio subsystems to the super-speed USB device's low-power states and non-low-power states. However, this is not a limitation of the present invention. The present disclosure may also applicable to any alternative design of other interface device in a similar manner.

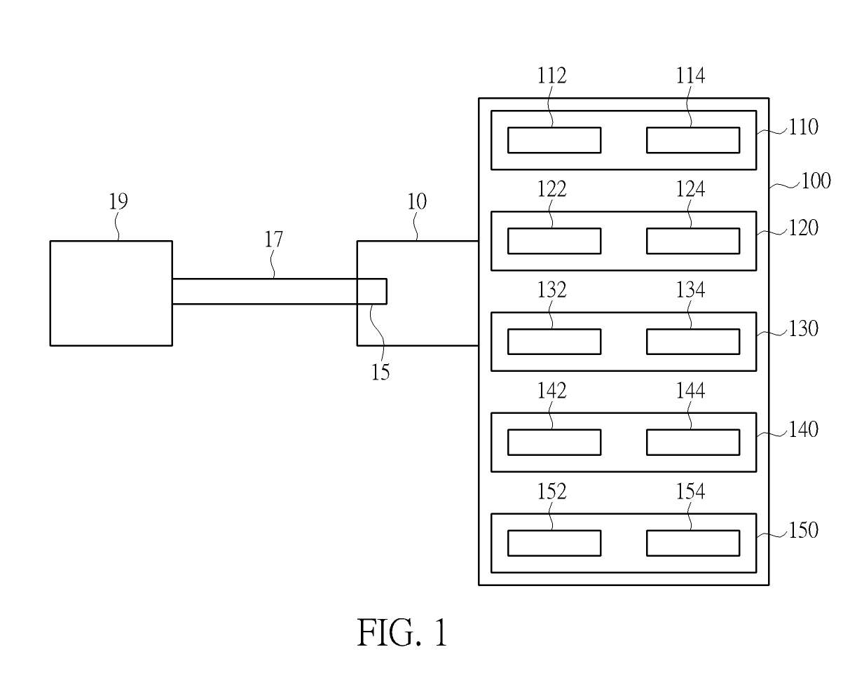

Please refer to FIG. 1, which is a schematic diagram illustrating a wireless communications system 100 co-located with a universal serial bus (USB) interface apparatus 10 (e.g., a super-speed USB device) according to a first embodiment of the present invention. The wireless communications system 100 and the USB interface apparatus 10 may be co-located in the same application device (e.g., a personal computer). The USB interface apparatus 10 includes a USB connector 15 and a USB cable 17. The USB connector 15 is arranged for connecting the USB interface apparatus 10 with the USB cable 17. The USB cable 17 is arranged for connecting the USB connector 15 with a USB peripheral device 19. The USB interface apparatus 10 operates in one of a plurality of operational states, including one operational state LP and another operational state NLP, and a power consumption of the USB interface apparatus 10 in the operational state LP is lower than a power consumption of the USB interface apparatus 10 in the operational state NLP. By way of example, but not limitation, the operational state LP may be regarded as a low-power state, and the operational state NLP may be regarded as a non-low-power state.

When the USB interface apparatus 10 operates in the operational state NLP, the USB connector 15 and/or the USB cable 17 are prone to radiate electromagnetic waves. The radiated electromagnetic waves maybe regarded as interference noises to the wireless communications system 100. Please note that, since the number of USB cables and USB connectors does not change the nature of electromagnetic wave radiation, the USB interface apparatus 10 may include more than one USB connector and more than one USB cable. Similar description is omitted for brevity. The wireless communications system 100 may include at least one radio subsystem. For example, the wireless communications system 100 includes a wireless fidelity (Wi-Fi) subsystem 110, a Bluetooth (BT) subsystem 120, a Zigbee subsystem 130, a time-division synchronous code division multiple access (TD-SCDMA) subsystem 140 and a time-division long term evolution (TD-LTE) subsystem 150. The WI-Fi subsystem 110 includes a Wi-Fi transmission circuit 112 and a Wi-Fi reception circuit 114. The Wi-Fi transmission circuit 112 is arranged for performing a WI-Fi transmission, and the Wi-Fi reception circuit 114 is arranged for performing a Wi-Fi reception when the USB interface apparatus 10 operates in the operational state LP. The BT subsystem 120 includes a BT transmission circuit 122 and a BT reception circuit 124. The BT transmission circuit 122 is arranged for performing a BT transmission, and the BT reception circuit 124 is arranged for performing a BT reception when the USB interface apparatus 10 operates in the operational state LP. The Zigbee subsystem 130 includes a Zigbee transmission circuit 132 and a Zigbee reception circuit 134. The Zigbee transmission circuit 132 is arranged for performing a Zigbee transmission, and the Zigbee reception circuit 134 is arranged for performing a Zigbee reception when the USB interface apparatus 10 operates in the operational state LP. The TD-SCDMA subsystem 140 includes a TD-SCDMA transmission circuit 142 and a TD-SCDMA reception circuit 144. The TD-SCDMA transmission circuit 142 is arranged for performing a TD-SCDMA transmission, and the TD-SCDMA reception circuit 144 is arranged for performing a TD-SCDMA reception when the USB interface apparatus 10 operates in the operational state LP. The TD-LTE subsystem 150 includes a TD-LTE transmission circuit 152 and a TD-LTE reception circuit 154. The TD-LTE transmission circuit 152 is arranged for performing a TD-LTE transmission, and the TD-LTE reception circuit 154 is arranged for performing a TD-LTE reception when the USB interface apparatus 10 operates in the operational state LP. Please note that, the wireless communications system 100 may only be one or a combination of the WI-Fi subsystem 110, the BT subsystem 120, the Zigbee subsystem 130, the TD-SCDMA subsystem 140 and the TD-LTE subsystem 150 according to different embodiments. However, it is for illustrative purpose only, and not meant to be a limitation of the present invention.

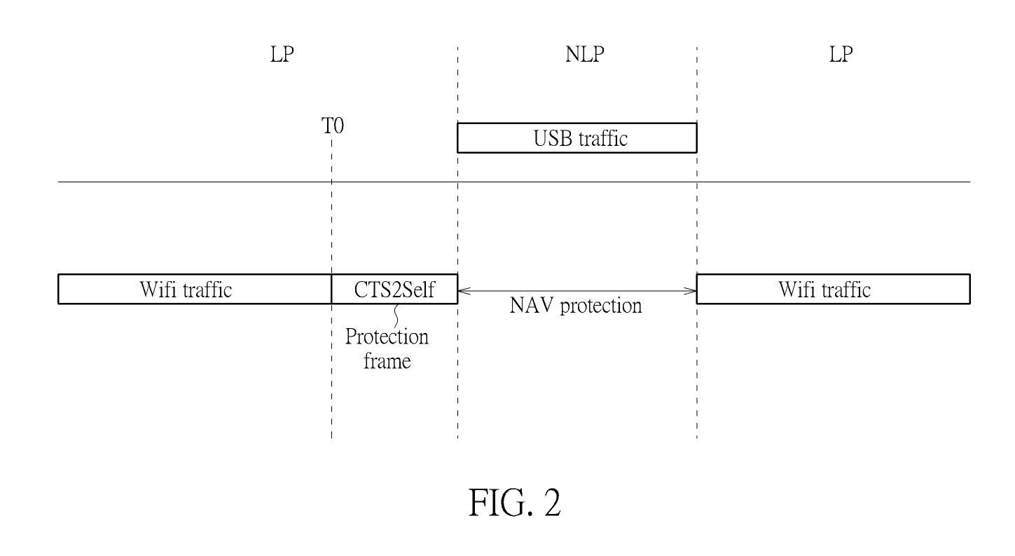

Please refer to FIG. 2, which is a schematic diagram illustrating a time-division multiplexing scheme for the wireless communications system 100 co-located with the USB interface apparatus 10 (e.g., a super-speed USB device) according to a second embodiment of the present invention. In FIG. 2, the upper half of the diagram illustrates a time line of operations of the USB interface apparatus 10, while the lower half of the diagram illustrates a time line of operations of the wireless communications system 100. In this embodiment, during a period in which the USB interface apparatus 10 operates in the operational state NLP, the Wi-Fi subsystem 110 halts its traffic (i.e., stops Wi-Fi transmission and Wi-Fi reception) in order to avert the radiated interference noises emitted from cable (s) or connector (s) of the USB interface apparatus 10. The Wi-Fi subsystem 110 may halt its traffic by sending a protection frame on a data-link layer to its corresponding peer at time TO, which is in a period in which the USB interface apparatus 10 operates in the operational state LP. For example, the protection frame may be a CTS2Self frame with a network allocation vector (NAV) sent by Wi-Fi transmission circuit 112 at a media access control (MAC) layer, and the NAV is configured to halt communications of the Wi-Fi subsystem 110 until the operational state NLP ends. Alternatively, the Wi-Fi transmission circuit 112 may send the protection frame configured to a fast power safe mode at a physical layer. However, it is for illustrative purpose only, and not meant to be a limitation of the present invention. When the corresponding peer receives the protection frame, it immediately stops sending packets to the Wi-Fi subsystem 110, and thus the incoming reception of the Wi-Fi subsystem 110 is suppressed until an end of the operational state NLP.

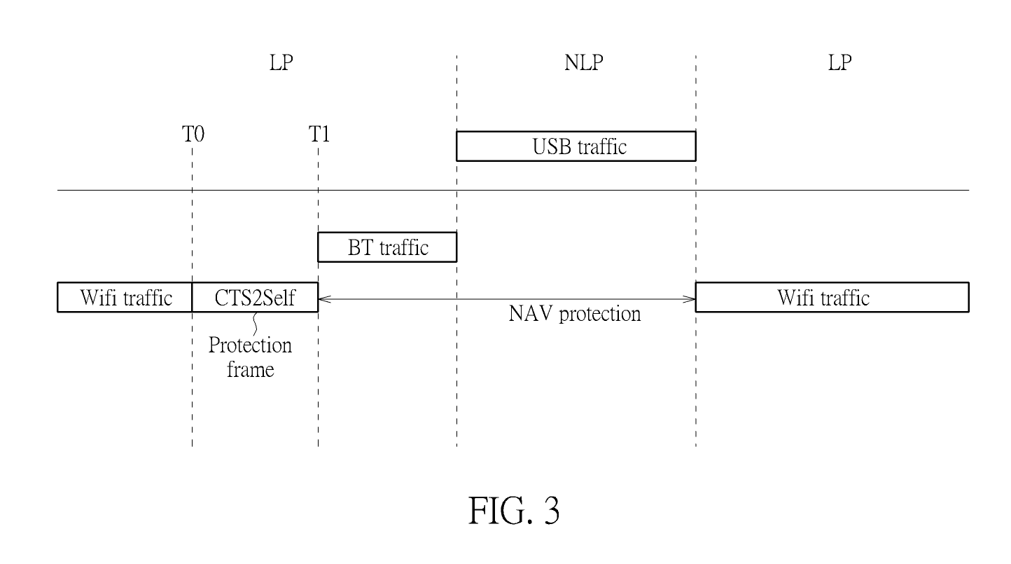

In a case where the wireless communications system 100 includes more than one radio subsystem, these radio subsystems may still operate in a time-division manner. Please refer to FIG. 3, which is a schematic diagram illustrating a time-division multiplexing scheme for the wireless communications system 100 co-located with the USB interface apparatus 10 (e.g., a super-speed USB device) according to a third embodiment of the present invention. In FIG. 3, the upper half of the diagram illustrates a time line of operations of the USB interface apparatus 10, while the lower half of the diagram illustrates a time line of operations of the wireless communications system 100. In FIG. 3, the Wi-Fi transmission circuit 112 sends a protection frame to its corresponding peer at time T0, and the protection frame takes effect at time T1, which is prior to a beginning of the operational state NLP of the USB interface apparatus 10. In this way, a period between T1 and the beginning of the operational state NLP (i.e., the remaining period of the present operational state LP) may be used by the BT subsystem 120 for transmission and/or reception. That is, after sending the protection frame, the BT transmission circuit 122 may perform BT transmission and the BT reception circuit 124 may perform BT reception during the remaining period of the operational state LP.

In addition, since the wireless communications system 100 and the USB interface apparatus 10 are co-located, it is reasonable to assume that the interference noise radiated from the cable(s) and the connector(s) of the USB interface apparatus 10 only affects the reception of the wireless communications system 100. Therefore, the present invention further takes advantage of this phenomenon and exploits the period in which the USB interface apparatus operates in the operational state NLP for performing wireless communications transmission.

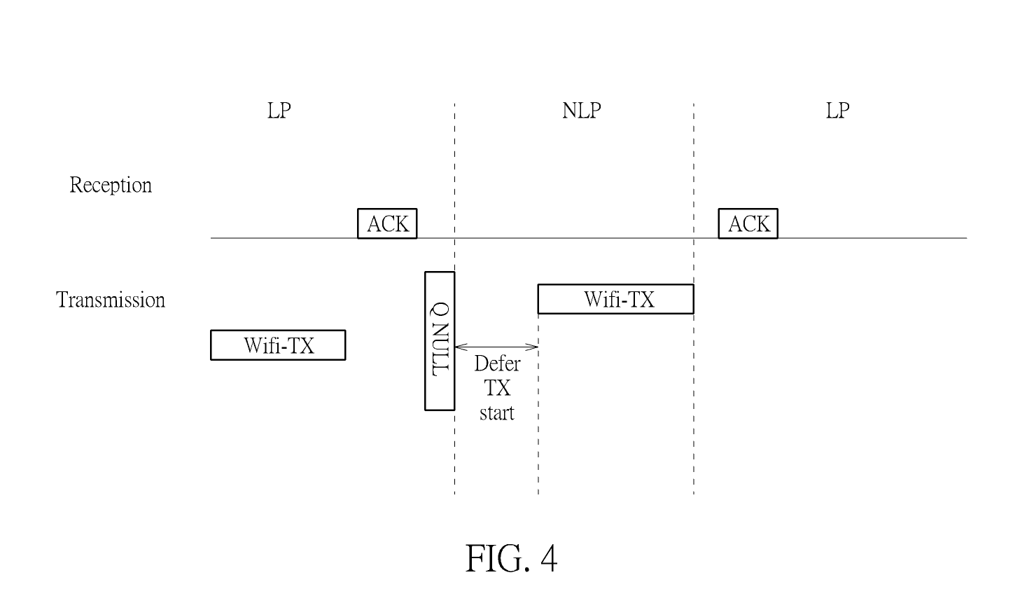

Please refer to FIG. 4, which is a schematic diagram illustrating a time-division multiplexing scheme for the wireless communications system 100 co-located with the USB interface apparatus 10 (e.g., a super-speed USB device) according to a fourth embodiment of the present invention. In FIG. 4, the upper half of the diagram illustrates communications reception of the wireless communications system 400, while the lower half of the diagram illustrates operations of communications transmissions of the wireless communications system 100. In a period in which the USB interface apparatus 10 operates in the operational state LP, the wireless communications system 100 is free to perform wireless communications transmission or wireless communications reception. However, in a period in which the USB interface apparatus 10 operates in the operational state NLP, the wireless communications system 100 is only allowed to perform wireless communications transmission. That is, wireless communications reception can only be performed during the period in which the USB interface apparatus 10 operates in the operational state LP. The wireless communications system 100 has to defer the transmission performed during the period in which the USB interface apparatus 10 operates in the operational state NLP such that an end of the transmission is aligned to an end of the operational state NLP of the USB interface apparatus 10 in order for a corresponding acknowledgement being properly received. In this embodiment, the Wi-Fi transmission is deferred by the Wi-Fi transmission circuit 112 sending a quality of service (QoS) null packet before a beginning of Wi-Fi transmission. The null packet includes a length field of a physical layer convergence protocol (PLCP) header configured to defer the beginning of the Wi-Fi transmission such that the end of the Wi-Fi transmission is aligned to the end of operational state NLP of the USB interface apparatus 10. In this way, the acknowledgement of the Wi-Fi transmission performed during the period in which the USB interface apparatus 10 operates in the operational state NLP can be properly received by the Wi-Fi reception circuit 114.

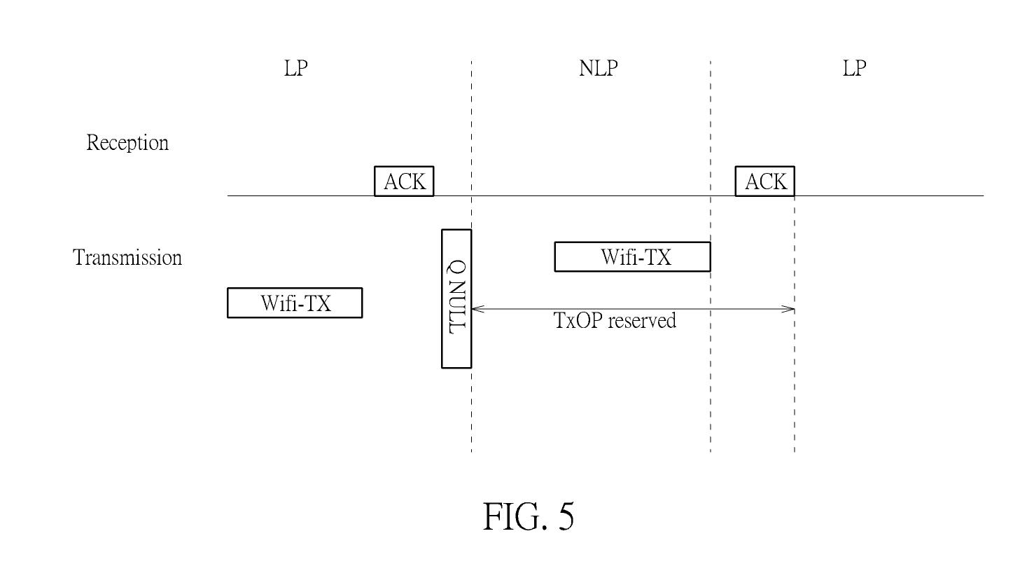

Please refer to FIG. 5, which is a schematic diagram illustrating a time-division multiplexing scheme for the wireless communications system 100 co-located with the USB interface apparatus 10 according to a fifth embodiment of the present invention. In FIG. 5, the upper half of the diagram illustrates communications reception of the wireless communications system 100, while the lower half of the diagram illustrates operations of communications transmissions of the wireless communications system 100. In this embodiment, the Wi-Fi transmission circuit 112 sends the null packet including a transmission opportunity (TxOP) interval in order to defer the Wi-Fi transmission performed during the period in which the USB interface apparatus 10 operates in the operational state NLP. The Wi-Fi transmission circuit 112 configures the TxOP interval to be longer than the period in which the USB interface apparatus 10 operates in the operational state NLP. More specifically, the TxOP interval should last at least from the beginning of the operational state NLP to an end of an acknowledgement of the Wi-Fi transmission performed during the period in which the USB interface apparatus 10 operates in the operational state NLP. In this way, the acknowledgement of the Wi-Fi transmission performed during the period in which the USB interface apparatus 10 operates in the operational state NLP can be properly received by the Wi-Fi reception circuit 114.

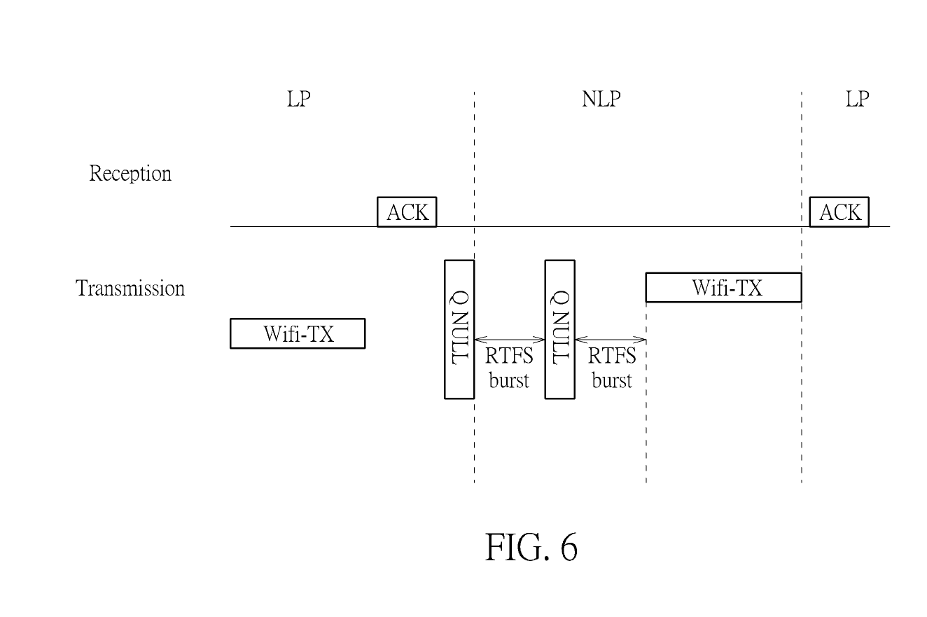

Please refer to FIG. 6, which is a schematic diagram illustrating a time-division multiplexing scheme for the wireless communications system 100 co-located with the USB interface apparatus 10 according to a sixth embodiment of the present invention. In FIG. 6, the upper half of the diagram illustrates communications reception of the wireless communications system 100, while the lower half of the diagram illustrates operations of communications transmissions of the wireless communications system 100. In this embodiment, the Wi-Fi transmission circuit 112 sends null packets with reduced inter-frame space (RIFS) burst to defer the beginning of the Wi-Fi transmission. The Wi-Fi transmission is then deferred to a point where the end of the transmission is aligned to the end of the operational state NLP of the USB interface apparatus 10. In this way, the acknowledgement of the Wi-Fi transmission performed during the period in which the USB interface apparatus 10 operates in the operational state NLP can be properly received by the Wi-Fi reception circuit 114.

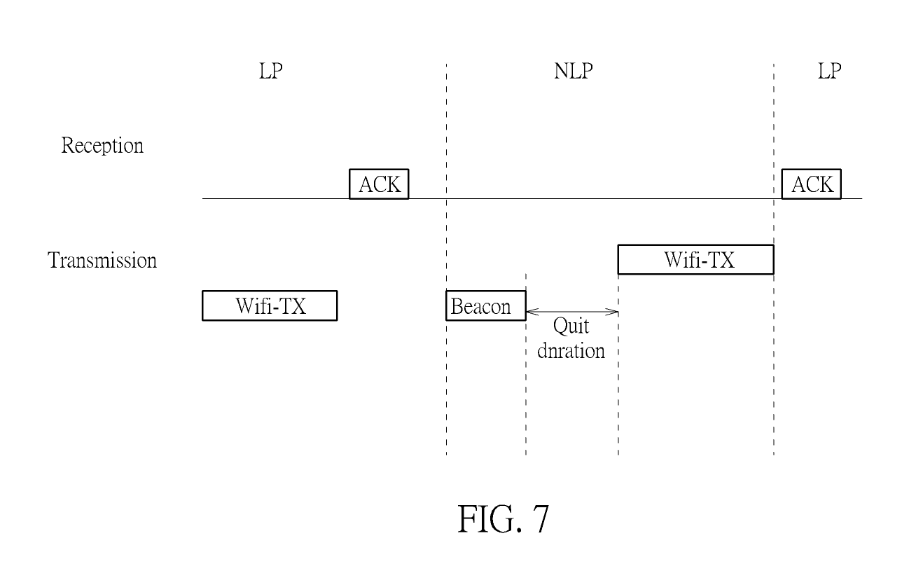

Please refer to FIG. 7, which is a schematic diagram illustrating a time-division multiplexing scheme for the wireless communications system 100 co-located with the USB interface apparatus 10 according to a seventh embodiment of the present invention. In FIG. 7, the upper half of the diagram illustrates communications reception of the wireless communications system 100, while the lower half of the diagram illustrates operations of communications transmissions of the wireless communications system 100. In this embodiment, the Wi-Fi transmission circuit 112 sends a beacon signal to defer the beginning of the Wi-Fi transmission. The beginning of the Wi-Fi transmission is deferred by the Wi-Fi transmission circuit 112 configuring a quiet duration of the beacon signal such that the end of the Wi-Fi transmission is aligned to the end of the operational state NLP of the USB interface apparatus 10. In this way, the acknowledgement of the Wi-Fi transmission performed during the period in which the USB interface apparatus 10 operates in the operational state NLP can be properly received by the Wi-Fi reception circuit 114. Please note that, the quiet duration of the beacon signal is set for all future Wi-Fi transmissions and thus should be used with cares.

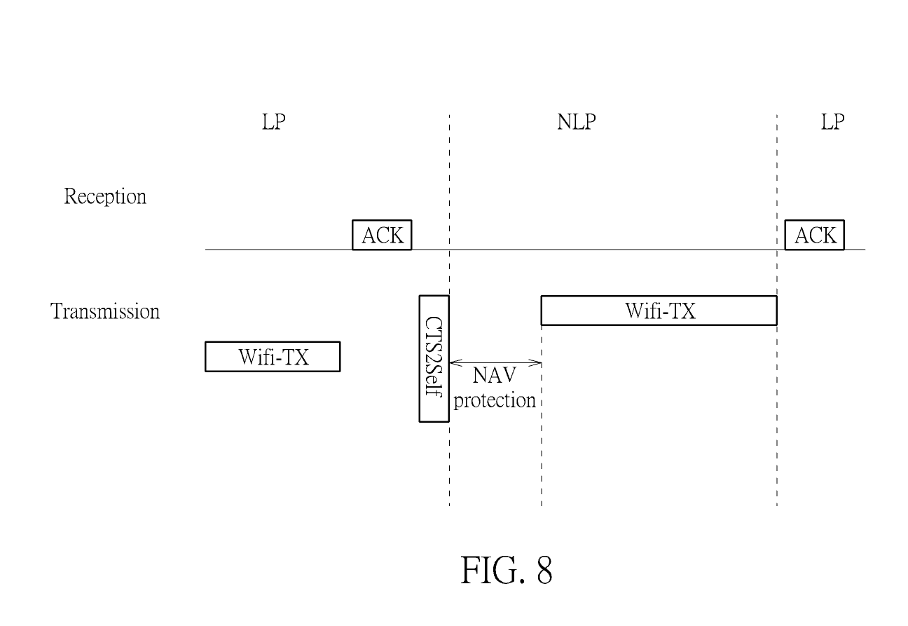

Please refer to FIG. 8, which is a schematic diagram illustrating a time-division multiplexing scheme for the wireless communications system 100 co-located with the USB interface apparatus 10 (e.g., a super-speed USB device) according to an eighth embodiment of the present invention. In FIG. 8, the upper half of the diagram illustrates communications reception of the wireless communications system 100, while the lower half of the diagram illustrates operations of communications transmissions of the wireless communications system 100. In this embodiment, the Wi-Fi transmission circuit 112 sends a CTS2Self frame to defer the beginning of Wi-Fi transmission. The beginning of the Wi-Fi transmission is deferred by the Wi-Fi transmission circuit 112 configuring a NAV of the CTS2Self frame such that the end of the Wi-Fi transmission is aligned to the end of the operational state NLP of the USB interface apparatus 10. In this way, the acknowledgement of the Wi-Fi transmission performed during the period in which the USB interface apparatus 10 operates in the operational state NLP can be properly received by the Wi-Fi reception circuit 114.

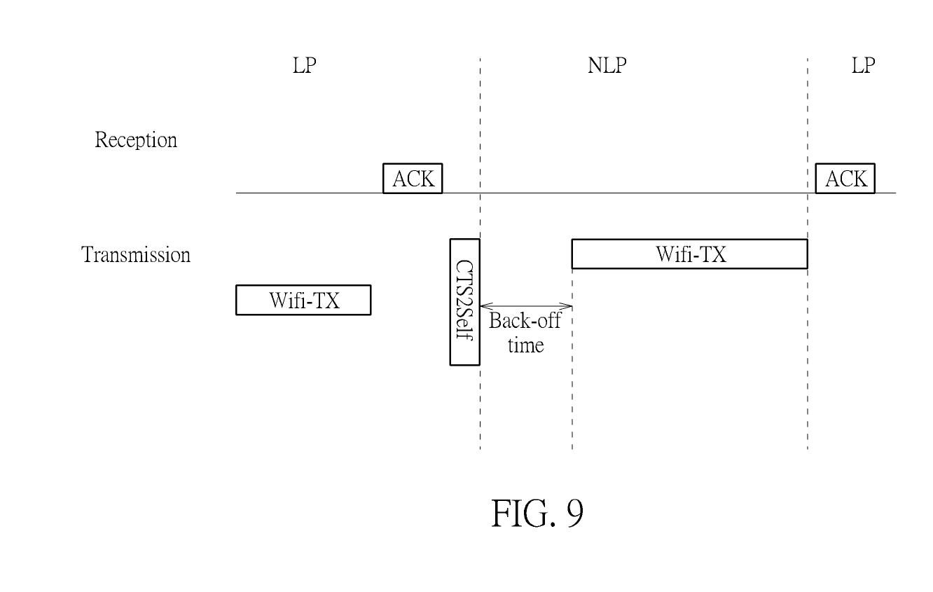

Please refer to FIG. 9, which is a schematic diagram illustrating a time-division multiplexing scheme for the wireless communications system 100 co-located with the USB interface apparatus 10 according to a ninth embodiment of the present invention. In FIG. 9, the upper half of the diagram illustrates communications reception of the wireless communications system 100, while the lower half of the diagram illustrates operations of communications transmissions of the wireless communications system 100. In this embodiment, the Wi-Fi transmission circuit 112 adjusts a back-off time of the Wi-Fi transmission to defer the beginning of Wi-Fi transmission. Please not that, if the back-off time is determined, the Wi-Fi transmission circuit 112 may adjust a transmission data rate of the Wi-Fi transmission as well to change a length of the Wi-Fi transmission such that the end of the Wi-Fi transmission is aligned to the end of the operational state NLP of the USB interface apparatus 10. In this way, the acknowledgement of the Wi-Fi transmission performed during the period in which the USB interface apparatus 10 operates in the operational state NLP can be properly received by the Wi-Fi reception circuit 114.

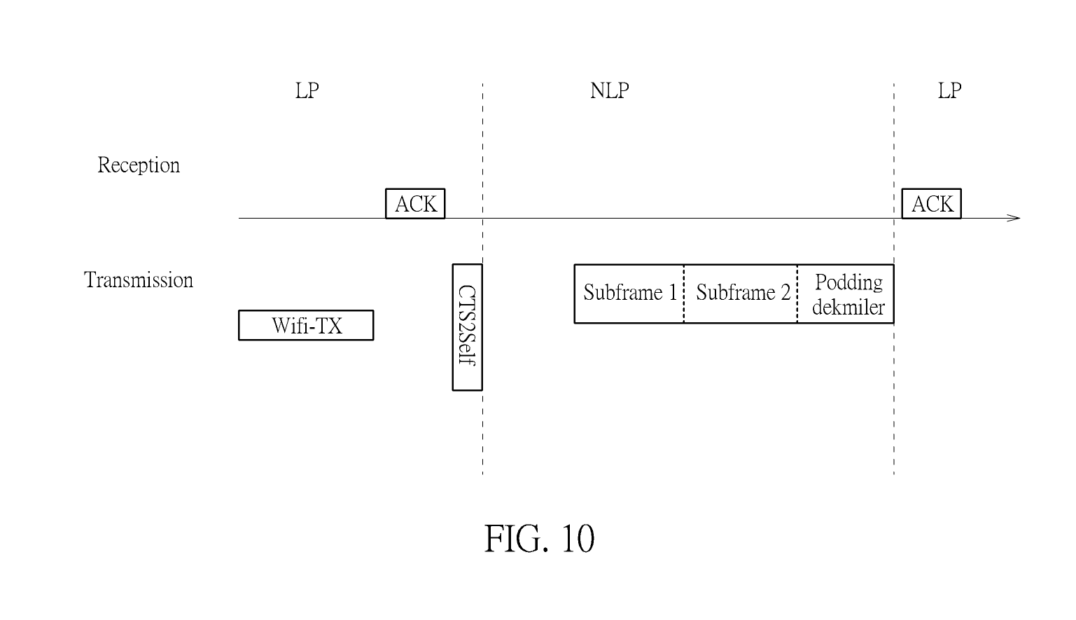

Please refer to FIG. 10, which is a schematic diagram illustrating a time-division multiplexing scheme for the wireless communications system 100 co-located with the USB interface apparatus 10 (e.g., a super-speed USB device) according to a tenth embodiment of the present invention. In FIG. 10, the upper half of the diagram illustrates communications reception of the wireless communications system 100, while the lower half of the diagram illustrates operations of communications transmissions of the wireless communications system 100. In this embodiment, if the wireless communications system 100 supports a block acknowledgement (BA), the Wi-Fi transmission circuit 112 may append padding delimiters (e.g., null delimiters) at the end of the Wi-Fi transmission to extend a length of the Wi-Fi transmission such that the end of the Wi-Fi transmission is aligned to the end of the operational state NLP of the USB interface apparatus 10. In this way, the BA of the Wi-Fi transmission performed during the period in which the USB interface apparatus 10 operates in the operational state NLP can be properly received by the Wi-Fi reception circuit 114.

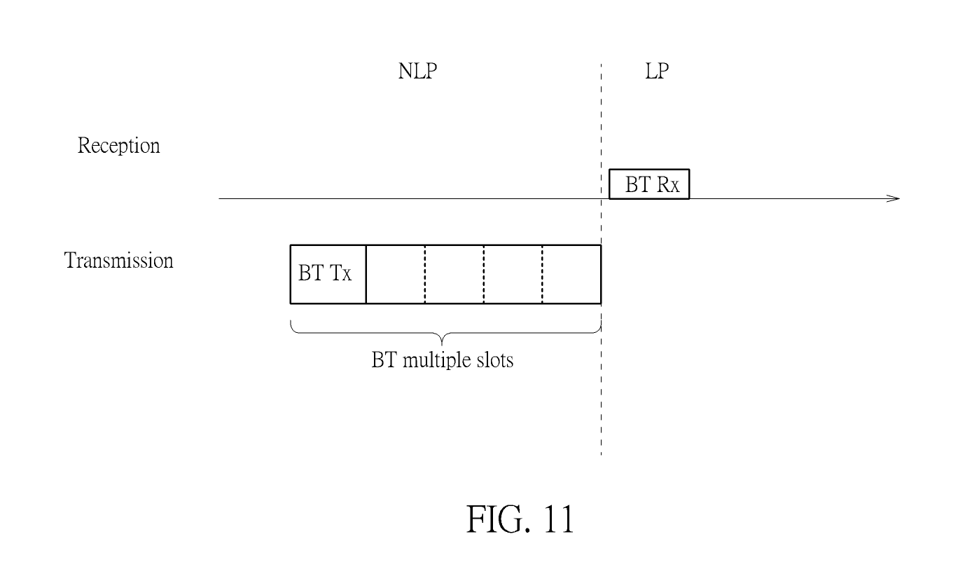

Please refer to FIG. 11, which is a schematic diagram illustrating a time-division multiplexing scheme for the wireless communications system 100 co-located with the USB interface apparatus (e.g., a super-speed USB device) according to an eleventh embodiment of the present invention. In FIG. 11, the upper half of the diagram illustrates communications reception of the wireless communications system 100, while the lower half of the diagram illustrates operations of communications transmissions of the wireless communications system 100. In this embodiment, the wireless communications transmission performed during the period in which the USB interface apparatus 10 operates in the operational state NLP is a BT transmission. Although the BT transmission does not require acknowledgements, the BT transmission circuit 122 still have to align an end of the BT transmission to the end of the operational state NLP of the USB interface apparatus 10 in order to ensure that a following BT reception is performed during the period in which the USB interface apparatus 10 operates in the operational state LP. In this embodiment, the BT transmission circuit 122 may employ BT multiple slots to extend a length of the BT transmission such that the end of the BT transmission is at least aligned to the end of the operational state NLP of the USB interface apparatus 10. In this way, the following BT reception will be properly received by the BT reception circuit 124 in the following period in which the USB interface apparatus 10 operates in the operational state LP.

In an alternative design, the BT communications may be used for audio/video transmission. That is, the BT transmission circuit 122 may employ BT synchronous connection-oriented (SCO) slots for transmission as well. In a case where the BT transmission circuit 122 employs BT-SCO slots for transmission, the BT transmission circuit 122 aligns each BT-SCO transmission slot to a corresponding period in which the USB interface apparatus 10 operates in the operational state NLP. In other words, each BT-SCO transmission slot should totally “occupy” corresponding period in which the USB interface apparatus 10 operates in the operational state NLP. In this way, each following BT-SCO reception slot will be properly received by the BT reception circuit 124 in a following period in which the USB interface apparatus 10 operates in the operational state LP.

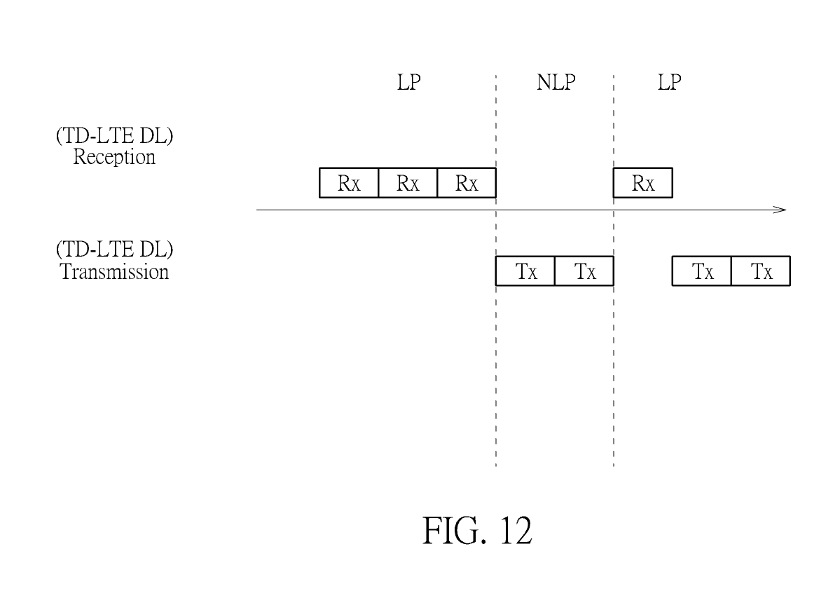

Please refer to FIG. 12, which is a schematic diagram illustrating a time-division multiplexing scheme for the wireless communications system 100 co-located with the USB interface apparatus 10 (e.g., a super-speed USB device) according to a twelfth embodiment of the present invention. In FIG. 12, the upper half of the diagram illustrates communications reception of the wireless communications system 100, while the lower half of the diagram illustrates operations of communications transmissions of the wireless communications system 100. In this embodiment, the wireless communications transmission performed during the period in which the USB interface apparatus 10 operates in the operational state NLP is a TD-LTE transmission. In FIG. 12, the LTE transmission frame is 5 ms and divided into 3 downlink slots followed by 2 uplink slots. The TD-LTE transmission circuit 152 aligns the 2 uplink slots to the period in which the USB interface apparatus 10 operates in the operational state NLP such that the downlink slots will only be received during the period in which the USB interface apparatus 10 operates in the operational state LP. In this way, a following TD-LTE reception will be properly received by the TD_LTE reception circuit 154 in a following period in which the USB interface apparatus 10 operates in the operational state LP.

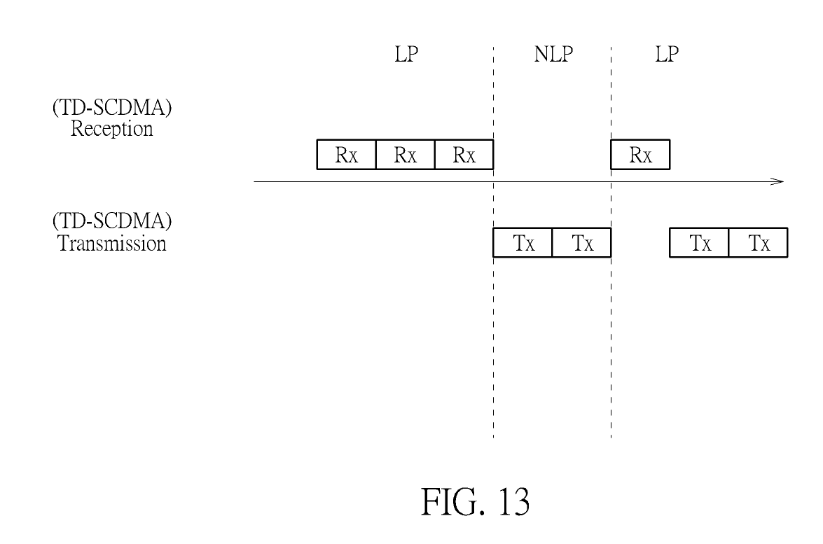

Please refer to FIG. 13, which is a schematic diagram illustrating a time-division multiplexing scheme for the wireless communications system 100 co-located with the USB interface apparatus 10 according to a twelfth embodiment of the present invention. In FIG. 13, the upper half of the diagram illustrates communications reception of the wireless communications system 100, while the lower half of the diagram illustrates operations of communications transmissions of the wireless communications system 100. In this embodiment, the wireless communications transmission performed during the period in which the USB interface apparatus 10 operates in the operational state NLP is a TD-SCDMA transmission. In FIG. 13, The TD-SCDMA transmission circuit 142 aligns the TD-SCDMA transmission to the period in which the USB interface apparatus 10 operates in the operational state NLP such that a following TD-SCDMA reception will only be received by the TD-SCDMA reception circuit 144 during the period in which the USB interface apparatus 10 operates in the operational state LP. In this way, a following TD-SCDMA reception will be properly received by the TD-SCDMA reception circuit 144 in a following period in which the USB interface apparatus 10 operates in the operational state LP.

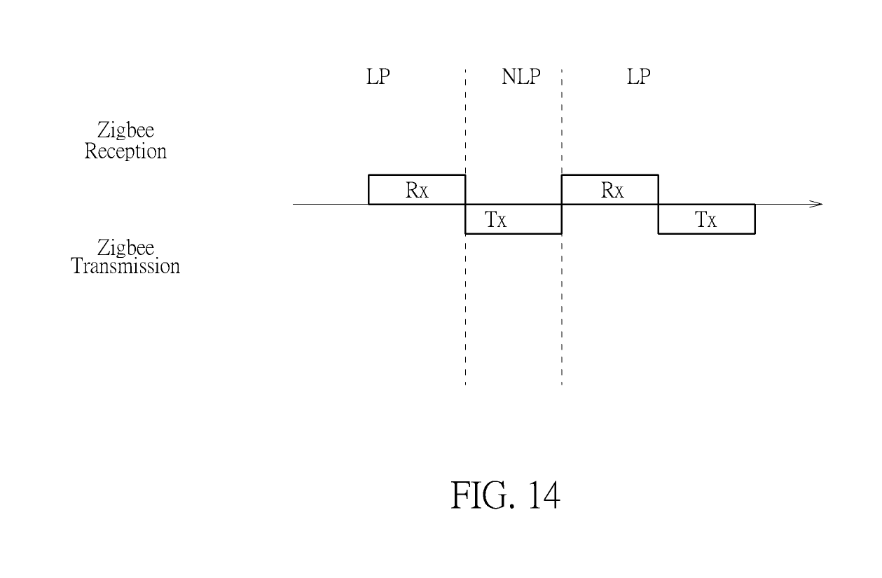

Please refer to FIG. 14, which is a schematic diagram illustrating a time-division multiplexing scheme for the wireless communications system 100 co-located with the USB interface apparatus (e.g., a super-speed USB device) according to a thirteenth embodiment of the present invention. In FIG. 14, the upper half of the diagram illustrates communications reception of the wireless communications system 100, while the lower half of the diagram illustrates operations of communications transmissions of the wireless communications system 100. In this embodiment, the wireless communications transmission performed during the period in which the USB interface apparatus 10 operates in the operational state NLP is a Zigbee transmission. In FIG. 14, Zigbee transmission circuit 132 aligns the Zigbee transmission to the period in which the USB interface apparatus 10 operates in the operational state NLP such that a following Zigbee reception will only be received by the Zigbee reception circuit 134 during the period in which the USB interface apparatus 10 operates in the operational state LP. In this way, a following TD-SCDMA reception will be properly received by the Zigbee reception circuit 134 in a following period in which the USB interface apparatus 10 operates in the operational state LP.

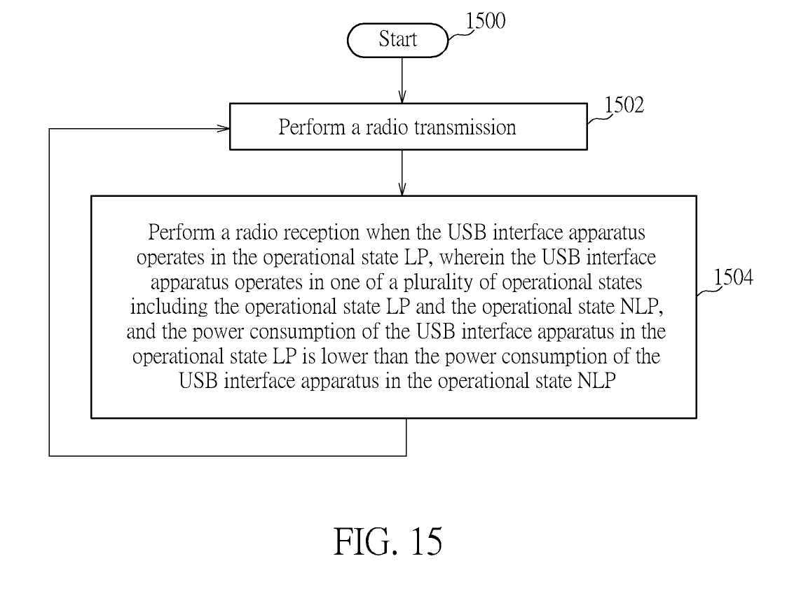

The operations of the above-mentioned wireless communications systems can be summarized into a flowchart. Please refer to FIG. 15, which is a flowchart of a wireless communications method employed by at least one subsystem of the wireless communications systems co-located with the USB interface apparatus. Provided that the result is substantially the same, the steps are not required to be executed in the exact order shown in FIG. 15. The exemplary control method may be briefly summarized by the following steps.

Step 1500: Start.

Step 1502: Perform a radio transmission.

Step 1504: Perform a radio reception when the USB interface apparatus operates in the operational state LP, wherein the USB interface apparatus operates in one of a plurality of operational states including the operational state LP and the operational state NLP, and the power consumption of the USB interface apparatus in the operational state LP is lower than the power consumption of the USB interface apparatus in the operational state NLP.

As a person skilled in the art can readily understand the operation of each step shown in FIG. 15 after reading the above paragraphs, further description is omitted here for brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communications system co-located with an interface apparatus, the wireless communications system, comprising:
a radio subsystem, comprising:
a transmission circuit; and
a reception circuit for performing a radio reception when the interface apparatus operates in a first operational state,
wherein the interface apparatus operates in one of a plurality of operational states including the first operational state and a second operational state, and a power consumption of the interface apparatus in the first operational state is lower than a power consumption of the interface apparatus in the second operational state.

2. The wireless communications system of claim 1, wherein the transmission circuit performs a radio transmission only when the interface apparatus operates in the first operational state.

3. The wireless communications system of claim 2, wherein the radio subsystem comprises a wireless fidelity (Wi-Fi) subsystem, and the Wi-Fi subsystem sends a protection frame to a corresponding peer to suppress incoming reception of the Wi-Fi subsystem during at least a period in which the interface operates in the second operational state.

4. The wireless communications system of claim 3, wherein the protection frame comprises a configured network allocation vector (NAV).

5. The wireless communications system of claim 3, wherein the protection frame is configured to a fast power safe mode.

6. The wireless communications system of claim 1, wherein the transmission circuit performs an aligned transmission during a period in which the interface apparatus operates in the second operational state.

7. The wireless communications system of claim 6, wherein an end of the aligned transmission is aligned to an end the period of the second operational state such that an acknowledgment of the aligned transmission is not received during a following period in which the interface apparatus operates in the first operational state.

8. The wireless communications system of claim 7, wherein the transmission circuit sends a quality of service (QoS) null packet with a length field of a physical layer convergence protocol (PLCP) header, where the length field is configured to align the end of the aligned transmission to the end of the period of the second operational state.

9. The wireless communications system of claim 7, wherein the transmission circuit sends a quality of service (QoS) null packet with at least one reduced inter-frame spacing (RIFS) burst to align the end of the aligned transmission to the end of the period of the second operational state.

10. The wireless communications system of claim 7, wherein the transmission circuit sends a beacon signal with a quiet duration configured to align the end of the aligned transmission to the end of the period of the second operational state.

11. The wireless communications system of claim 7, wherein the transmission circuit sends a quality of service (QoS) null packet with a transmit opportunity (TxOP) interval configured to be at least longer than the period of the second operational state such that the end of the aligned transmission is aligned to the end the period of the second operational state.

12. The wireless communications system of claim 7, wherein the transmission circuit sends a protection frame with a network allocation vector (NAV) configured to align the end of the aligned transmission to the end of the period of the second operational state.

13. The wireless communications system of claim 12, wherein the transmission circuit aligns the end of the aligned transmission to the end of the period of the second operational state by configuring a back-off time and a transmission data rate of the aligned transmission.

14. The wireless communications system of claim 12, wherein the transmission circuit aligns the end of the aligned transmission to the end of the period of the second operational state by appending at least one null delimiter to the end of the aligned transmission.

15. The wireless communications system of claim 6, wherein the transmission circuit aligns the end of the aligned transmission to the end of the period of the second operational state by sending Bluetooth (BT) multiple slots.

16. The wireless communications system of claim 1, wherein the interface apparatus is an universal serial bus (USB).

17. A wireless communications method for a radio subsystem co-located with an interface apparatus, the wireless communications method comprising:
performing a radio reception when the interface apparatus operates in a first operational state,
wherein the interface apparatus operates in one of a plurality of operational states including the first operational state and a second operational state, and a power consumption of the interface apparatus in the first operational state is lower than a power consumption of the interface apparatus in the second operational state.

18. The wireless communications method of claim 17, wherein the step of performing the radio transmission is performed only when the interface apparatus operates in the first operational state.

19. The wireless communications method of claim 17, wherein the at least one radio subsystem comprises a wireless fidelity (Wi-Fi) subsystem, and wireless communications method further comprises:
sending a protection frame to a corresponding peer of the Wi-Fi subsystem to suppress incoming reception of the Wi-Fi subsystem during at least a period in which the interface operates in the second operational state.

20. The wireless communications method of claim 1, further comprising:
performing an aligned transmission during a period in which the interface apparatus operates in the second operational state.
